(19) United States
(12) Patent Application Publication
(10) Pub. No.: US 2006/0190889 A1
(43) Pub. Date: Aug. 24, 2006

(54) Circuit floorplanning and placement by look-ahead enabled recursive partitioning

(76) Inventors: Jingsheng Jason Cong, Pacific Palisades, CA (US); Michail Romesis, Eindhoven (NL); Joseph R. Shinnerl, Los Angeles, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/331,769

(22) Filed: Jan. 16, 2006

Related U.S. Application Data
(60) Provisional application No. 60/644,115, filed on Jan. 14, 2005.

(51) Int. Cl. G06F 17/50

(52) U.S. Cl. 716/8

(57) ABSTRACT

Placement or floorplanning of an integrated circuit is performed by constructing legal layouts at every level of a hierarchy of subsets of modules representing the integrated circuit, by scalably incorporating legalization into each level of the hierarchy, so that satisfiability of constraints is explicitly enforced at every level, in order to eliminate backtracking and post-hoc legalization.

### CROSS-REFERENCE TO RELATED APPLICATIONS

This application is related to the following co-pending and commonly-assigned application:

U.S. Provisional Patent Application Ser. No. 60/644,115, filed on Jan. 14, 2005, by Jingsheng J. Cong, Michail Romesis, and Joseph R. Shinnerl, entitled “CIRCUIT FLOORPLANNING AND PLACEMENT BY LOOK-AHEAD ENABLED RECURSIVE PARTITIONING,” attorneys docket number 30435.169-US-P1 (2005-328);

which application is incorporated by reference herein.

### STATEMENT REGARDING FEDERALLY SPONSORED RESEARCH AND DEVELOPMENT

This invention was made with Government support under Grant No. CCF-0430077 awarded by the National Science Foundation, and Grant No. CCR-0096383 awarded by the National Science Foundation. The Government has certain rights in this invention.

### BACKGROUND OF THE INVENTION

1. Field of the Invention

The present invention relates to the design of integrated circuits, and more specifically, to circuit floorplanning and placement.

2. Description of the Related Art

(Note: This application references to various publications as indicated in the specification by reference numbers enclosed in brackets, e.g., [x]. A list of these publications ordered according to these reference numbers can be found below in the section entitled “References.” Each of these publications is incorporated in its entirety by reference herein.)

Fast floorplanning and placement are critical in the hierarchical physical design of Very Large Scale Integration (VLSI) circuits. System designers require a means of rapidly estimating the variation in performance of alternative architectures and logic designs. Multiscale and mixed-size placement algorithms typically solve some form of floorplanning or coarse placement problem at the first level of approximation, in order to generate an initial coarse layout for subsequent iterative refinement. With the reuse of intellectual property (IP) modules for multi-million-gate Application Specific Integrated Circuits (ASICs) and System-On-Chip (SOC) designs, most modern integrated circuit (IC) designs consist of a large number of standard cells mixed with many big macros, such as read-only memories (ROMs), random access memories (RAMs) and other IP modules. When clusters of standard cells are placed simultaneously with macros, the clusters may be treated as soft modules.

Large-scale floorplanning. Many floorplanning algorithms have been developed in recent years, varying mostly in the representation of geometric relationships among modules. They can be divided into two major categories: slicing and non-slicing algorithms. The first slicing algorithms were developed in the 1980's (e.g. [31], [35]). In the 1990's, non-slicing algorithms became more popular, especially after the introduction of the BSG [30] and Sequence Pair [29] representations. Other non-slicing representations include TCG [28], B-tree [19], CBL [26], O-tree [24], and so on. Simulated Annealing (SA) has been used to minimize area and/or wirelength under each of these representations.

Until a few years ago, the inherent slowness of SA was partially hidden by the lack of any need to floorplan more than 100 blocks at a time. Recently, however, growing numbers of IP blocks have increased the sizes of most floorplanning instances, prompting researchers to seek non-stochastic approaches.

Ranjan et al. [32] proposed a two-stage fast floorplanning algorithm. In the first stage, a hierarchy is generated by top-down recursive bipartitioning. Cutline orientations are selected from the bottom up in a way that keeps subregion aspect ratios close to one. In the second stage, low temperature SA improves wirelength by reshaping blocks to produce a more compact layout. Final, total wirelength was comparable to or better than that obtained by an SA-based algorithm [35], with speed-up of over 1000× in predictor mode (high-speed) and 20× in constructor mode (high-effort).

More recently, a fast algorithm called Traffic [33] has been used to generate high-quality floorplans without simulated annealing. Traffic also uses two stages. In the first stage, the blocks are divided into layers by linear multi-way partitioning. In the second stage, every layer is optimized individually; the blocks in each layer are separately arranged into rows and then moved among the rows to balance row widths and reduce wirelength. In the end, pairs of rows are squeezed tightly after being transformed into trapezoids. This final step leads to very compact floorplans, but it also increases wirelength, because the cells are ordered according to their heights.

The impressive speedups obtained by the last two algorithms raise the question of whether a fast deterministic approach can be used to replace the widely used SA engine with the same or better solution quality. As commonly practiced, floorplanning by recursive bipartitioning makes no guarantee that the blocks assigned to a subregion can actually be shaped and arranged there without overlap. In this scenario, defining base cases may be difficult, as many base cases may fail to have legal solutions.

Large-scale mixed-size placement. Compared to standard-cell placement, most of the increased difficulty in mixed-size placement is attributable to overlap removal, or legalization. Although in general legalization is NP-complete, legalization of a standard-cell placement is typically easy, because all standard cells have the same height and differ only in their widths. Most placement tools are able to produce legal standard-cell solutions, even when little white space is available, without sacrificing much wirelength. However, when large multi-row blocks are added to the design, placement becomes similar to floorplanning in complexity. In this context, it is often possible that even a good legalization algorithm can fail to find an overlap-free placement which retains the basic structure of a given global placement. Moreover, in designs of high row utilization, i.e., low white space, experiments show that publicly available state-of-the-art software may fail to find a legal solution altogether, even when a given global placement is known to be good in both wirelength and block density distribution.

Currently, the best published wirelength results are obtained by methods requiring legalization after global placement. FengShui 5.1 [36] uses recursive-bisection with iterative deletion, iterative repartitioning, relaxed rows not aligned with standard cell rows (“fractional cut′”), and a simple Tetris-style approach to legalization. APlace [37, 38] employs a multiscale, force-directed formulation.

Most other previously published correct-by-construction algorithms for mixed-size placement rely on simulated annealing in some crucial way. mPG [39] builds a cluster hierarchy for multiscale optimization in a physical-hierarchy-generation framework. mPG uses simulated annealing (SA) on the Sequence-Pair [40] floorplanning representation over nested grids at every level of the cluster hierarchy for legalization. Reliance on SA slows mPG down considerably.

Capo 9.3[6] proceeds top down by cutsize-driven recursive bipartitioning until certain ad-hoc tests suggest that newly generated subproblems may be difficult to legalize. At that point, standard cells in each subproblem are clustered, and these clusters are treated as soft macros. SA-based fixed-outline floorplanning is then attempted on the hard macros and soft clusters for the given subregion. If it succeeds, the locations of the macros are then fixed, and further refinement proceeds on the declustered soft macros. If it fails, then the subproblem is merged with its sibling, the previous partition of the parent subproblem is discarded, and floorplanning is attempted for the parent subproblem. In principle, this backtracking may continue indefinitely until some ancestor is successfully floorplanned or until failure at the top level occurs. In practice, the ad-hoc tests used to determine when to commence floorplanning are observed to be good enough that backtracking is only rarely needed. However, when white space is particularly scarce, e.g., less than 4%, Capo 9.3 reports failures, presumably because its ad-hoc tests are insufficient to prevent floorplanning on subproblems that are too large for its SA-based floorplanner to solve scalably.

In another alternative, CPLACE [32] proposed a partitioning-based placer that incorporates explicit legalization into every level of the top-down partitioning hierarchy. In CPLACE, this progressive legalization supports accurate modeling of complex constraints such as irregular images, fixed objects, fixed IOs, large objects, timing-driven placement, and free-space distribution. However, legalization at each level is performed after partitioning without any formal assurance of its success.

Consequently, although many methods for the placement [1, 2, 3, 4, 6, 7, 8, 9, 10, 14] or floorplanning [5, 15] of integrated circuits have been developed in recent years, there remains a need in the art for improved methods of placement and floorplanning of integrated circuits, especially one where the need for post-hoc legalization is completely removed. The present invention satisfies that need.

### SUMMARY OF THE INVENTION

The present invention describes a new paradigm for the floorplacement of any combination of fixed-shape and variable-shape modules under tight fixed-outline area constraints and a wirelength objective. (The term “floorplacement” is used to refer simultaneously to any combination of floorplanning and placement.) Dramatic improvement over traditional floorplacement methods is achieved by (i) explicit construction of strictly legal layouts for every partition block at every level of a top-down hierarchy and (ii) the use of these legal layouts at intermediate levels to guarantee legal, overlap free termination at the final bottom levels of the partitioning hierarchy. By scalably incorporating legalization into the hierarchical flow, post-hoc legalization is successfully eliminated. For large floorplanning benchmarks, the present invention generates solutions with half the wirelength of state-of-the art floorplanners in orders of magnitude less run time. In particular, compared to widely used simulated annealing based floorplanners, the present invention seeks to achieve 30× to 500× speedup with better wirelength results. The present invention also has application to large-scale mixed-sized placement.

### BRIEF DESCRIPTION OF THE DRAWINGS

Referring now to the drawings in which like reference numbers represent corresponding parts throughout:

FIG. 1 is an exemplary hardware and software environment used to implement the preferred embodiment of the invention; and

FIG. 2 is a flowchart that illustrates the design and optimization flow performed by an electronic design automation (EDA) tool that performs a method for placement or floorplacement of an integrated circuit according to the preferred embodiment of the present invention.

### DETAILED DESCRIPTION OF THE INVENTION

In the following description of a preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

Overview

The present invention, referred to here as PATOMA, includes techniques described in [22] and [23]. It is a novel methodology and algorithm for the placement and/or floorplanning of integrated circuits. The problem involves placing elements of integrated circuits in a two-dimensional or three-dimensional placement region. The placeable elements are called “modules.” Modules may be standard cells, IP macros, logic elements, or any other elements of an integrated circuit.

The placement or floorplanning is cast as the minimization of a given objective associated with the performance of the circuit, subject to constraints. The objective may be any function which increases when the weighted sum of all distances between or among interconnected modules is increased, in any distance metric, such as the sum of the half-perimeter wirelengths of the nets. Constraints include but are not limited to (i) the requirement that no two modules overlap; (ii) bounds on the number of allowed inputs inside any subregion of the chip; (iii) bounds on the aspect ratios of any modules which may be continuously reshaped, (iv) timing requirements [16], and (v) routing resources [12]. There is no restriction on the type or number of additional constraints that may be considered, other than the stipulation that it is possible to compute some configuration for which all constraints are satisfied.

The present invention defines a floorplacement flow by recursive partitioning in which the satisfiability of all constraints is explicitly enforced at every step, so that the need for post-hoc legalization is completely removed. Recursive partitioning is applied simultaneously both to the set of modules and to the region they occupy, each module subset assigned to one subregion. The objective of the partitioning can be weighted cutsize, i.e., the sum of the weights of the nets containing modules in multiple subsets of the partition, or displacement from a given global placement solution which, typically, has not yet been legalized. (Net weights can be defined to model various design objectives and constraints, e.g., timing delay, routability, etc.)

Legal or feasible look-ahead solutions, strictly satisfying all constraints, are explicitly constructed for every subproblem at each intermediate level, before optimizing partitioning is applied to that subproblem. A fast and greedy “guarantor” algorithm is used to compute these look-ahead or “prelegalized” solutions. The guarantor determines whether the objects assigned to each given subregion can in fact be shaped and laid out within that subregion without violation of the constraints. If all child subproblems of a given parent subproblem can be legalized by the guarantor, then recursive, optimizing partitioning continues on those child subregions at the current level, and the legal solution of the parent subproblem is discarded. If, however, some child subproblem cannot be legalized, then optimizing partitioning is not attempted on it or any of its siblings. Instead, an objective-reducing instantiation of the previously computed, legal, look-ahead solution to the parent subproblem is used. Partitioning coupled with subproblem legalization then resumes recursively on these subproblems, until single-module base cases are reached. A principal result of this flow is that, during or after the top-down partitioning process, backtracking to find feasible placement solutions is eliminated completely.

Compared to recursive-partitioning-based floorplacement as commonly practiced in VLSI CAD [3, 4, 7, 8, 11, 13], including the most recent work in [6], the elimination of any possibility of backtracking feasibility search is the most significant difference. This new approach is in general more robust than the previous state of the art, enabling successful solution under far tighter fixed-resource conditions than could previously be considered. It also consistently improves solution quality, by quantifying subproblem resource requirements early in the top-down process. These advantages incur no serious loss in speed or scalability compared to existing techniques.

The present invention is implemented for both floorplanning [22] and mixed-sized placement [23]. In the floorplanning problem, modules are allowed to be reshaped within a discrete or continuous set of aspect ratios under a non-overlapping constraint. Three guarantors have been used depending on the characteristics of the subproblems: a Zero-Dead-Space (ZDS) soft-block floorplanning algorithm, a Row-Oriented Block packing (ROB) algorithm, and a standard-cell Row-based Block-Packing (RBP) algorithm. Details of the implementation of this methodology and the look-ahead guarantors can be found later in this specification, as well as in the parent application referenced above.

For large-scale floorplanning benchmarks, the present invention generates solutions with approximately half the wirelength of state-of-the art simulated-annealing-based floorplanners faster, such as about 200 times faster in some cases. In the placement problem, all modules have fixed shape. Standard cells all have the same height and must be aligned in rows. Macros may have any height larger than or equal to the standard-cell height. In this setting, the performance of the present invention is significantly more robust than that of other, leading partitioning-based placement tools, with no serious loss in speed or scalability. Under very low white space (approximately 1-5% or less), the present invention can consistently compute legal solutions. In addition, the present invention consistently achieves better total wirelength than other circuit placers: about 10% less than Capo [4] and about 2% less than FengShui [3], on standard IBM test cases.

In one embodiment, only cutsize has been used as the partitioning objective. Some embodiments employ displacement from global analytical placements instead, so that the present invention can be integrated with mPL5 [2]. For other embodiments, timing delay may also be optimized. Some constraints may be considered in the implementation, such as module shape and pairwise non-overlap in embodiments. These may also be augmented to incorporate routability, temperature, noise, etc, in embodiments.

PATOMA Floorplanning Algorithm

As noted above, the present invention attempts to minimize total wirelength under a fixed-outline area constraint. It couples top-down, cutsize-driven, recursive bipartitioning with fast, area-driven floorplanning on all subproblems.

Pseudo-code for the PATOMA floorplanning algorithm of the present invention is provided below:

PATOMA Floorplanning Algorithm

input: Set of blocks S = {r₁, . . ., rₘ}; netlist; aspect ratio constraints

for each block, rectangle R of fixed shape.

Each node of the partitioning tree is a set of blocks paired with a
subregion.

Generate the root node (S, R) at level i = 1, and a legal floorplan for the
root.

while there are still blocks to be placed

while there are unvisited nodes at level I

Select unvisited node n = (Sₙ, Sₙ) of level i.
Use terminal propagation to model connections

between bᵢ ε Sₙ and bⱼ ∉ Sₙ.

Call hMetis to partition Sₙ into disjoint subsets Sₙ₁ and

Sₙ₂, resp. assigned subregions Rₙ₁, Rₙ₂ of Rₙ.

done : = false.
repeat

remark Binary search for cutline position.

for i = 1, 2

if (all blocks in Sₙᵢ are soft)

fit[i] : = ZDS(Sₙᵢ, Rₙᵢ).

else

fit[i] : = ROB(Sₙᵢ, Rₙᵢ).

end if

end for
if (fit[j] and not fit[k], j, k ε {1, 2})

slide the cutline toward Rₙⱼ

else done : = true.
end if

until (done or cutline search limit reached)
if (fit[1] and fit[2])

Create child nodes n₁ and n₂ of n.
Store the solutions from or ZDS or ROB for possible
future use.

else replace the hMetis bipartitioning of (Sₙ, Rₙ) with a

bipartitioning derived from earlier application of ZDS or ROB.

end if

end while
i : = i + 1.

end while
output: A floorplan of S in R satisfying all area and aspect-ratio
constraints.

At every level of the cutsize-driven, area-bipartitioning hierarchy, each node corresponds to a subset of blocks assigned by terminal propagation to a specific rectangular subregion of the chip. Before each application of cutsize-driven bipartitioning, however, one of two separate fast, area-driven floorplanners is used to check whether the given subproblem can be legalized.

The fast floorplanner determines by a slicing construction whether the blocks assigned to each given subregion can in fact be shaped and laid out within that subregion without overlap. If so, then recursive cutsize-driven area bipartitioning continues in both subregions at the current level. If not, then the cutsize-driven solution at that level is discarded, and a wirelength-reducing symmetry of the previously computed, legal, “look-ahead” solution to the parent subproblem is used instead. (Failure of ZDS (see below) or ROB (see below) to find a legal initial solution, prior to recursive bipartitioning, is highly unlikely.) Because ZDS and ROB both produce slicing structures, their top-level cuts define floorplanning subproblems with known legal solutions. Cutsize-driven partitioning coupled with subproblem legalization then resumes recursively on these subproblems, until single-block base cases are reached.

The area-driven look-ahead floorplanners determine whether a legal solution exists for a given fixed-shape subregion and block subset. These algorithms must be fast and must usually find legal solutions if they exist. The first area-driven floorplanner, ZDS, is based on a recent study [20] of sufficient conditions for zero-dead-space floorplanning of soft blocks.

ZDS is used only when all the blocks in the subregion are soft. Otherwise, a second area-driven floorplanner based on ROB is used. ROB is somewhat similar to Traffic [33]; however, it handles both soft and hard blocks under a fixed-outline constraint. Both algorithms perform well in reasonable run time. They are reviewed below.

As noted above, the present invention uses the well-known multilevel partitioning package hMetis [27]. Neither of the two block subsets produced is allowed to hold more than 60% of the total area of all blocks in both subsets. This choice of area balance produced the best results in experiments. Terminal propagation is used to account for connections between partitions.

Using feedback from the look-ahead floorplanners, the present invention redistributes white space in order to make the result of cutsize-driven partitioning legalizable as often as possible. The exact location of the cutline is initially set in direct proportion to the total areas of the blocks in every partition. If a legal solution is found initially for R₁ but not for its sibling R₂, it may still be possible to find a legal solution for both partitions by moving white space from R₁ to R₂, i.e., by moving the cutline away from R₂ and toward R₁. Candidate cutline positions can be generated by binary search, as long as each cutline position results in a legal solution in at least one of the partitions.

Wirelength-Aware ZDS Floorplanning

ZDS floorplanning is used in the present invention only when all blocks are soft. The ZDS algorithm ignores wirelength. Under conditions reviewed below, its result is a ZDS floorplan with the aspect ratios of all blocks bounded between ⅓ and 3. Both the original ZDS algorithm [20] and extensions to it are reviewed herein.

Let the blocks be sorted by nonincreasing areas, a₁≧ . . . ≧aN, and let β be the maximum ratio of the areas of any two consecutive blocks; β=maxᵢ{aᵢ/aᵢ₊₁}. Let γ=max {2,β}. An analysis shows that, if all block aspect ratios ρᵢ are allowed to range freely in [1/(γ+1), γ+1], then a zero-dead-space floorplan for this set of blocks can be found for any given region with area equal to the sum of the areas of the blocks and any fixed aspect ratio in [1/(γ+1), γ+1].

The ZDS algorithm proceeds as follows. At each step, the blocks are sorted according to their area, and the largest block is examined. If it fills up at least 1/γ of the area of its enclosing subregion, it is shaped and placed flush against one side of that subregion. A cut is made for the remaining unplaced sorted blocks such that the resulting subsets' total areas are as nearly equal as possible. The subregion is then cut parallel to its shorter side so that the areas of the resulting subregions equal those of the two partitioned block sets. Cutting parallel to the shorter side keeps aspect ratios of subregions bounded in terms of the area variation among the blocks.

The ZDS algorithm is very fast, both asymptotically (O(n log n)) and in practice (it floorplans 300 blocks in a few seconds). All the Gigascale Research Center (GSRC) soft-block-packing benchmarks can be solved optimally by this algorithm; i.e., all blocks can be shaped and placed with zero dead space and with all blocks' aspect ratio constraints ⅓≦ρᵢ≦3 satisfied. Thus, its required conditions are not very restrictive.

The present invention extends the original ZDS algorithm in two ways.

First, available dead space is used to increase the frequency with which ZDS satisfies all aspect-ratio constraints. Let ρₘₐₓ denote the maximum aspect ratio allowed for any block. When γ+1≦ρₘₐₓ, success of ZDS is guaranteed, because the aspect ratios of the subregions for which ZDS is called are also in the range [1/ρₘₐₓ, ρₘₐₓ], by the partitioning and cutline decisions made at the higher levels of the hierarchy. When γ+1>ρₘₐₓ, the effective value of γ can be reduced by padding some of the blocks by dead space. If the reduction in y is not enough to guarantee success, the ZDS algorithm is applied anyway, because its conditions for the creation of a legal solution are sufficient but not necessary. Second, in the original ZDS algorithm, the side of a subregion in which a block or block subset is placed is left unspecified. In the present invention, when ZDS must be used instead of cutsize-driven bipartitioning to guarantee legalizability of the resulting subproblems, each block subset is placed in the subregion side that reduces the total lengths of connections between blocks in the subset and other blocks.

ROB Floorplanning

The ROB heuristic is used by the present invention for floorplanning is a combination of fixed- and variable-dimension blocks. It is similar to Traffic [33] in that it organizes the blocks by rows according to their dimensions; however, it satisfies a fixed-outline constraint and handles both hard and soft blocks.

Assume given a set of blocks to be placed in a region with fixed height H and fixed width W. If H>W, the blocks will be organized in rows; otherwise, in columns. By organizing blocks in rows along the shorter subregion dimension, there is room to pack more rows, and therefore a wider variety of block heights can be efficiently supported. For the rest of this section, it is assumed, for simplicity, that the blocks are packed in rows.

ROB ignores connectivity. It consists of two stages. In the first stage, the blocks are grouped into rows according to their dimensions. In the second stage, emptier rows are merged with fuller rows until all rows fit inside the given, fixed-shape region. During the first stage, blocks are considered one by one and either added to existing rows or used to create new ones. Hard blocks are considered first. For every block, if one of its dimensions matches the height of an existing row and its addition to that row does not create overflow, it is placed there. Otherwise, a new row is generated with height equal to the smaller dimension of the block. Soft blocks are considered next. As they can be reshaped, they are more likely to match the height of an existing row. When a block can fit in multiple rows, the shortest one is preferred. If no such row can be found, a new one is generated with height equal to the smallest possible dimension of the block.

At the end of the first stage, a set of rows has been generated. Each row width is less than the fixed width W of the region, but it is possible that the sum of the row heights is larger than the fixed height H of the region. In the second stage, some rows are eliminated by redistributing blocks one by one. The rows are scanned in a decreasing height order. Blocks from rows shorter than the currently selected one are added to the selected row where possible. Priority is given to rows of smallest width.

When a block is moved to another row, it is allowed to be rotated or reshaped for the purpose of matching the height of its new row as closely as possible without exceeding it. The procedure is repeated until either all the rows have been scanned, or enough rows have been eliminated such that the sum of the heights of the remaining rows is less than H. In the first case, the algorithm ends without finding a legal solution, while in the second it reports a success.

When legalizability of a cutsize-driven partition of a given subproblem cannot be ensured, ROB's solution to that subproblem is employed instead, by interpreting it as a partition.

Since the solution of ROB is organized in rows (columns), it is guaranteed to have at least one slicing horizontal or vertical cut that can be used as the cutline for a bipartitioning of the blocks.

The bipartitionings generated by these cuts are compared with their symmetric ones for wirelength, and the best bipartitioning is selected to replace the infeasible hMetis solution.

Mixed-Sized Placement By RBP

The adaptation of the PATOMA flow to mixed-sized placement is a significant enhancement of the floorplanning implementation described above. The placement implementation, referred to as PolarBear, replaces ROB with a standard-cell-row aware rectangle packing subrouting, known as a Row-oriented Block Packing (RBP) algorithm, which is described below. It also incorporates several standard techniques for legalizing intermediate results of cutsize driven partitioning, in order that reliance on prelegalized solutions may be deferred for as long as possible. Finally, when use of a prelegalized solution becomes necessary to assure legal termination, the attempted cutsize-driven partition is used as a target template to improve the given prelegalized solution in a way that does not sacrifice its legality.

Pseudocode for the PolarBear algorithm is set forth below.

PolarBear Mixed-Size Placement

input: Set of hard blocks V = {v1, : : : ; vn}; netlist H = (V; E);

rectangular region R of fixed dimensions.

remark: Each node of the bipartitioning tree is a triple: (i) a set of

blocks V, (ii) a rectangular subregion R, and (iii) a legalized placement
P(V; R) of V in R.

Apply RBP to V in R.
if (RBP fails to prelegalize V in R)

Report a failure of PolarBear to the caller and exit.

else

Denote RBP's legal placement of V in R by P.
Set the root node to (V; R; P).

end if
Create a queue Q of prelegalized placement subproblems.
enqueue the root node (V; R; P) in Q.
while (Q is nonempty) do

dequeue a prelegalized subproblem S = (V; R; P).

Partition V into disjoint subsets V1; V2 by hMetis with terminal

propagation. Slice R into subregions R1, R2, and assign V1, V2 to them.

Let P1 := RBP(V1; R1) and P2 := RBP(V2; R2).
notation: Pi is true if and only if Pi is legal.
if (not (P1 and P2))

if (cutline search legalizes P1 and P2)

continue

else if (repartitioning legalizes P1 and P2)

continue

else if (block swapping legalizes P1 and P2)

continue

else refine P = RBP(V; R) to reconstruct

legal P1 and P2.

end if
remark. P1 and P2 are now legal.
if (jV1j > 1) enqueue (V1; R1; P1) in Q.
if (jV2j > 1) enqueue (V2; R2; P2) in Q.

end do
output: a legal placement of V inside region R

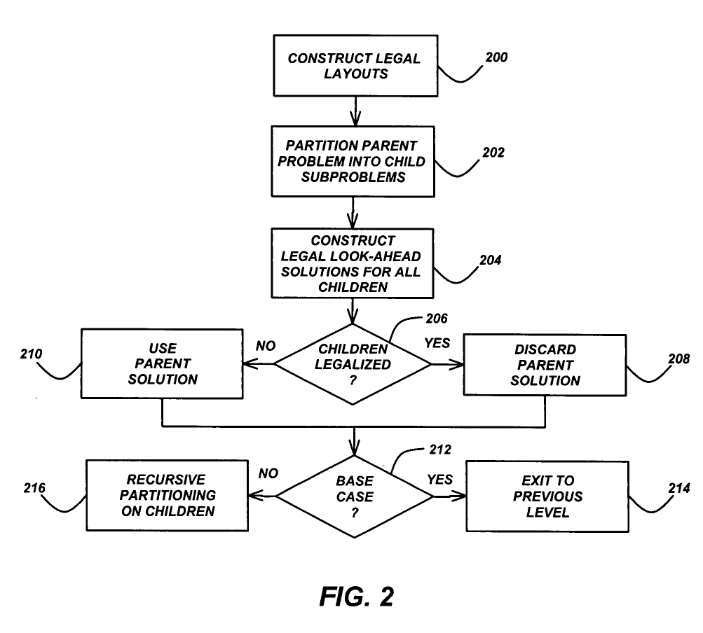

Prelegalization by RBP. Prelegalization in PolarBear is an extremely simple form of row-oriented block packing, called RBP. Macros and cells are taken in non-increasing-height order and placed in consecutive rows in the subregion. Each block is placed in the first row in which it fits in a way that preserves at least one slice. Individual rows are filled from left to right. Macros typically span multiple rows. Therefore, stacks of smaller blocks may appear to the right of larger blocks. (See, for example, FIG. 2 in [23].) The top edge of a block is not allowed higher than the top edge of its left neighbor. If at any point, a macro or a standard cell cannot fit in the specified region, the algorithm reports failure. The row-oriented structure ensures that either (i) a horizontal slice along a row boundary exists; or, (ii) the tallest macro spans all rows, creating a vertical slice.

As indicated above, if RBP initially fails to find a legal solution to a given sub-problem, four separate corrective measures are attempted in sequence. The first three measures, cutline repositioning, repartitioning, and iterated block swapping, are not guaranteed to legalize. When they succeed, however, they preserve a given cutsize-driven partitioning as closely as possible. If all three fail, then cutsize-driven partitioning of the parent subproblem is abandoned, and the prelegal RBP solution to the parent subproblem is instead adopted and refined. Overall, these improved feedback measures reduce PolarBear's average total wirelength by 15-20%, on average.

Cutline Search. When RBP finds a legal solution to one of the subproblems but not the other, the cutline can be moved away from the failed case and toward the solved one. A limited number of iterations (3-12) of binary search on the cutline position is performed. The block subsets of the subregions are held fixed, and for each candidate cutline position, RBP is attempted anew on the same block subsets in the new candidate subregions.

Repartitioning. If one of the placement subproblems still cannot be solved after cutline search, the entire process is repeated for up to 10 new hMetis partitionings or until legality is obtained for both subproblems. Experiments to date produce the best quality/run-time tradeoff with 2 runs of hMetis for each of 5 different balance factors: 10, 15, 5, 20, and 25%. Overall, replacing these multiple runs of hMetis by just one run at balance factor 10% increases total wirelength by 9%.

Iterated Block Swapping. When repartitioning and cut-line search reach their limits, the first hMetis solution with 10% balance factor is restored for attempted correction by iterative refinement. Suppose that RBP successfully finds a legal placement for subregion A but not for its sibling sub-region, B. Usually, a small number of small adjustments to the given cutsize-driven partitioning success to determine legal solutions to both subproblems. A partial solution of B is generated by running RBP while skipping the placement of the blocks that do not fit in the subregion. The legal solution to A and the partial solution to B are used as a starting point. First, the blocks not contained in B by its partial solution are moved across the cutline from B to A. This step legalizes the placement in B but typically renders the solution to A illegal. In order to re-legalize A, the cutline is first moved as far toward B as possible, so that the width of B is the same as the width of the widest row of blocks there. Then, RBP is rerun on the new subproblem for A. If RBP fails on this new subproblem, then the above steps are repeated with the roles of regions A and B reversed. This refinement continues up to a maximum of 10 iterations until either (i) legal placements to both subregions are found, or (ii) cycling occurs; i.e., a given set of leftover blocks appears more than once for different iterations of the same subproblem. When a legal target layout is found, there are usually multiple blocks of the same dimensions which can be relocated in order to obtain the legal layout from the original. The blocks actually moved are selected to reduce wirelength, as estimated by placing all pins at subregion centers.

Experiments demonstrate that iterated block swapping is the most effective of the correction heuristics used in PolarBear. When it is omitted, average total wirelength increases by 14%, while run time decreases by only 3%.

Refining an RBP Solution. If iterated block swapping fails to legalize a given placement subproblem, then PolarBear returns to its parent subproblem, for which a legal RBP solution has already been computed and stored. A non-legalized target solution to this subproblem is then computed by traditional min-cut placement: recursive cutsize-driven bipartitioning coupled with terminal propagation, cut-line specification, and assignment of the block subsets to the subregions defined by the cutline position. Locations of blocks in this target solution are used to guide the refinement of the given RBP solution, as follows. Blocks of identical dimensions in the RBP solution are permuted in order to move them as close to their locations in the target solution as possible. In other words, the original RBP solution is viewed as a template for the ultimate assignment of its blocks to the subregions currently associated with the blocks.

In PolarBear, the permutation is generated by sorting the block locations in the RBP solution by their y-coordinates, if a partition along the x-dimension will follow, or by their x-coordinates, if the partition will be along the y-dimension. The target locations are sorted in the same fashion. Juxtaposing these orderings gives the assignment.

The permuted RBP placement is bipartitioned, and the main algorithm resumes separately on each of its two child subproblems. In order to guarantee the legality of subproblem solutions, the permuted RBP placement is partitioned along one of its row or column boundaries, and not by generic, cutsize-driven hMetis bipartitioning. A few nearly centered, row or column-separating cutlines for the RBP solution and its symmetric solution (flipped across the cutline) are considered for its bipartitioning. For each of these candidates, wirelength is estimated by placing all blocks in each subregion at the subregion's center and modeling external connections by terminal propagation. The selected cutline produces the least estimated wirelength. On average, this refinement of the guarantor RBP solution reduces final, total wirelength by 3%.

### EXPERIMENTAL RESULTS

The inventors compared PATOMA to Parquet-2[17], a state-of-the art SA-based floorplanner using Sequence Pair geometric representation, Traffic [33] and FFPC, the fast floorplanner of Ranjan et al. [32]. For a fair comparison, all experiments were performed on the same machine, a 2.4 GHz Pentium IV running RedHat Linux 8.0. Result tables are omitted; they can be found in a technical report [21]. The inventors compared on four sets of benchmarks. For all the experiments, the floorplanners are trying to minimize the wirelength in a fixed outline. The first set of benchmarks includes the 4 largest GSRC circuits (size 200-300 blocks), where all the blocks are soft. For this set, The inventors compared only to Parquet-2, because in addition to the high-quality floorplans it produces, it is, as far as is known, the only freely available package online that can consider both fixed-outline constraints and soft blocks.

The inventors ran Parquet-2 in two modes. The first mode is the default and is very fast, due to a shorter simulated-annealing schedule that hurts the wirelength quality. The second mode is a high-effort mode, where a time limit of one hour was imposed to allow SA to attain a better solution. In the all-soft-block examples, PATOMA uses only the ZDS algorithm and not ROB to enforce the legalizability of all floorplanning subproblems.

All blocks are allowed to be reshaped with any aspect ratios in [1/3,3]. The default mode of Parquet-2 produces results that are 19% higher in wirelength than PATOMA, while its runtime is 37× slower. The high-effort mode of Parquet-2 is 11% worse in wirelength and 824× slower than PATOMA.

The second set of experiments includes the same GSRC benchmarks, but with all blocks of given, fixed dimensions. In these examples, PATOMA uses only ROB and not ZDS to enforce the legalizabilty of floorplanning subproblems, because all blocks are hard. On these benchmarks, PATOMA produces results of 10% lower wirelength than the default mode of Parquet-2, with a speedup of 33×, and of 5% lower wirelength than the high-effort mode of Parquet-2, with an average speedup of 523×.

The third set of experiments includes the same GSRC circuits all blocks hard, but without pads. PATOMA was compared with Traffic and FFPC for these benchmarks, since these floorplanners do not use pads or shape soft blocks. FFPC's wirelength is 3% longer than PATOMA's, on average, while its run time is 6× longer. With Traffic's run-time limit set to PATOMA's run time, Traffic's average total wirelength is 60% longer than PATOMA's.

In the fourth set of experiments, the inventors generated large-scale floorplanning benchmarks from the IBM/ISPD98 suite [18] that include both hard and soft blocks on a fixed die with 20% whitespace. The soft blocks are clusters of standard cells generated by the First-Choice clustering heuristic [27]. The hard blocks are the same macros as in the original benchmarks. The allowed range of aspect ratios for the soft blocks was set at [1/3, 3]. The sizes of the benchmarks range from 500 to 2,000 blocks. This suite of benchmarks is called the HB-suite (hybrid blocks). These benchmarks are available online [25]. For these examples, Parquet-2's wirelength is on average 104% higher than PATOMA's, while it is 209× slower.

The inventors also performed separate experiments with the PolarBear algorithm. The PolarBear algorithm was implemented with the gcc 3.2.3 compiler on a 2.4 GHz Pentium 4 processor in a Red-Hat 9.0 Linux environment. It was compared with two leading mixed-size placement algorithms publicly available online: FengShui 5.1[30] and Capo 9.3 [27]. Both these tools use recursive bipartitioning, but their methodologies are different.

FengShui is very aggressive during global placement; it shows relatively little consideration for nonoverlapping constraints. After global placement, it uses a simple Tetris-like legalization algorithm [11, 18] to remove overlap. However, this combination consistently fails to pro-duce legal placements on the ICCAD04 benchmarks when white space is decreased below 10%.

Capo 9.3 uses back-tracking and SA-based floorplanning to construct correct layouts without post-hoc legalization. However, as white space decreases to near 3%, it often reports failures also, presumably because its backtracking proceeds to subproblems too large for its floorplanner to handle with acceptable run time, so it resorts to a macro legalization procedure that is not guaranteed to work in all cases.

In these experiments, PolarBear was run on the IBM/ICCAD 2004 bench-marks for mixed-size placement [2] with the default 20% white space. On average over these examples, Capo 9.3's wirelengths are 1.0% longer than PolarBear's, and FengShui 5.1's wirelengths are 0.8% longer than PolarBear's.

Twenty different versions of the benchmarks were generated by setting the white space available in the placement region from 1% up to 20% white space in increments of 1%. PolarBear is clearly much more robust than FengShui 5.1 and Capo 9.3. It successfully computed a legal placement for every benchmark tested, with every value of white space, down to 1% white space. Solutions produced by FengShui 5.1 are consistently legal over all the benchmarks only with white space at least 15%. Solutions produced by Capo 9.3 are consistently legal over all the benchmarks only with white space at least 5%. Capo 9.3 typically does find legal solutions when white space is as low as 1%, but not consistently.

Computer Implementation

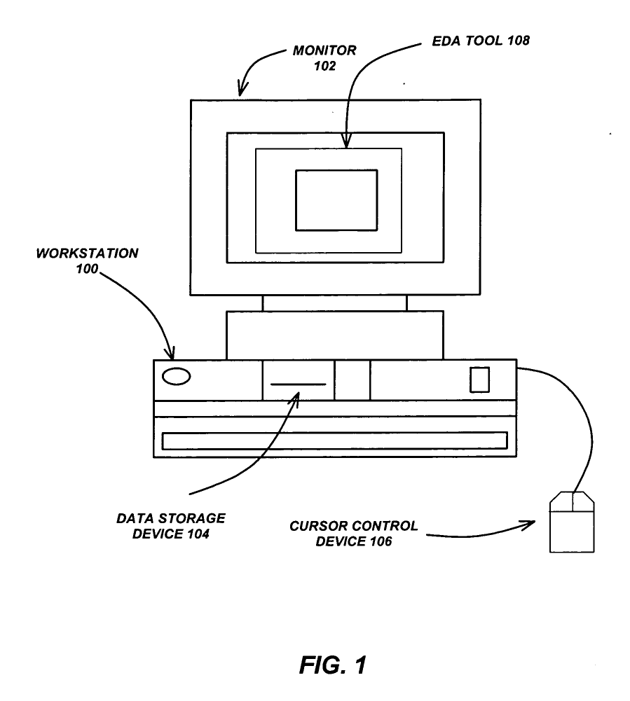

FIG. 1 is an exemplary hardware and software environment used to implement the preferred embodiment of the invention. The preferred embodiment of the present invention is typically implemented using a workstation 100, which generally includes, inter alia, a monitor 102, data storage devices 104, cursor control devices 106, and other devices. Those skilled in the art will recognize that any combination of the above components, or any number of different components, peripherals, and other devices, may be used with the workstation 100.

The preferred embodiment of the present invention is implemented by an electronic design automation (EDA) tool 108 executed by the workstation 100, wherein the EDA tool 108 is represented by a window displayed on the monitor 102. Generally, the EDA tool 108 comprises logic and/or data embodied in or readable from a device, media, carrier, or signal, e.g., one or more fixed and/or removable data storage devices 104 connected directly or indirectly to the workstation 100, one or more remote devices (such as servers) coupled to the workstation 100 via data communications devices, etc.

Those skilled in the art will recognize that the exemplary environment illustrated in FIG. 1 is not intended to limit the present invention. Indeed, those skilled in the art will recognize that other alternative environments may be used without departing from the scope of the present invention.

FIG. 2 is a flowchart that illustrates the design and optimization flow performed by the EDA tool 108 according to the preferred embodiment of the present invention. Specifically, FIG. 2 discloses a method for placement or floorplanning of an integrated circuit.

Block 200 represents the step of constructing legal layouts at every level of a hierarchy of subsets of modules representing the integrated circuit, by scalably incorporating legalization into each level of the hierarchy, so that satisfiability of constraints is explicitly enforced at every level, in order to eliminate backtracking and post-hoc legalization. In this Block, the hierarchy of subsets of modules may be derived by top-down recursive partitioning of the modules or by recursive bottom-up aggregation or clustering of modules and subsets. Further, the constructing step is performed using any combination of fixed-shape and variable-shape modules under tight fixed-outline area constraints and a wirelength objective. Finally, the method's objective is minimization of any combination of: estimated weighted wirelength, routability, signal timing delay, power consumption, temperature, Block 202 represents the step of partitioning the hierarchy of modules in which satisfiability of all constraints is explicitly enforced at every step, so that the need for post-hoc legalization is completely removed. The partitioning objective is the minimization of either weighted cutsize or displacement from a given global placement solution that has not yet been legalized.

Block 204 represents the step of constructing legal look-ahead solutions, strictly satisfying all constraints, for every subproblem at each intermediate level, before optimizing partitioning is applied to those subproblems. A guarantor algorithm is used in this Block to compute the legal look-ahead solutions, and the guarantor algorithm determines whether objects assigned to each given subregion can be shaped and laid out within that subregion without violation of the constraints.

Block 206 is a decision block that determines if all child subproblems of a given parent subproblem can be legalized by the guarantor algorithm.

If all child subproblems of a given parent subproblem can be legalized by the guarantor algorithm, then recursive, optimizing partitioning continues on those child subregions at the current level, and the legal solution of the parent subproblem is discarded, as represented by Block 208.

If some child subproblems cannot be legalized, then optimizing partitioning is not attempted on it or any of its siblings, and instead, an objective-reducing instantiation of the previously computed, legal, look-ahead solution to the parent subproblem is used, as represented by Block 210.

In either case, partitioning coupled with subproblem legalization resumes recursively on these subproblems, until single-module base cases are reached.

Block 212 is a decision block that determines if the current level of the hierarchy of modules is a base case.

If the current level of the hierarchy of modules is a base case, then control exits to the previous recursion level or, if all modules have been shaped and placed, to the calling program, as represented by Block 214.

If the current level of the hierarchy of modules is not a base case, then recursion on the child subproblem is performed, as represented by Block 216.

### REFERENCES

The following references are incorporated by reference herein:
[1] Dragon, http://er.cs.ucla.edu/Dragon/
[2] mPL, http://cadlab.cs.ucla.edu/cpmo/
[3] FengShui, http://vlsicad.cs.binghamton.edu/
[4] Capo, http://vlsicad.ucsd.edu/GSRC/bookshelf/Slots/Placement/Capo/
[5] Parquet, http://vlsicad.eecs.umich.edu/BK/parquet/
[6] S. N. Adya, S. Chaturvedi, J. A. Roy, D. A. Papa and I. L. Markov, “Unification of Partitioning, Floorplanning and Placement,” Intl. Conf. Computer-Aided Design (ICCAD), San Jose, Calif., November 2004, pp. 550-557.
[7] U.S. Pat. No. 6,826,737, issued Nov. 30, 2004, to Teig, et al., entitled Recursive partitioning placement method and apparatus.
[8] U.S. Pat. No. 6,671,867, issued Dec. 30, 2003, to Alpert, et al., entitled Analytical constraint generation for cut-based global placement.
[9] U.S. Pat. No. 6,516,455, issued Feb. 4, 2003, to Teig, et al., entitled Partitioning placement method using diagonal cutlines.
[10] U.S. Pat. No. 6,442,743, issued Aug. 27, 2002, to Sarrafzadeh, et al., entitled Placement method for integrated circuit design using topo-clustering.
[11] U.S. Pat. No. 6,249,902, issued Jun. 19, 2001, to Igusa, et al., entitled Design hierarchy-based placement.
[12] U.S. Pat. No. 5,798,936, issued Aug. 25, 1998, to Cheng, entitled Congestion-driven placement method and computer-implemented integrated-circuit design tool.
[13] U.S. Pat. No. 5,640,327, issued Jun. 17, 1997, to Ting, entitled Apparatus and method for partitioning resources for interconnections.
[14] U.S. Pat. No. 5,566,078, issued Oct. 15, 1996, to Ding, et al., entitled Integrated circuit cell placement using optimization-driven clustering.
[15] U.S. Pat. No. 5,532,934, issued Jul. 2, 1996, to Rostoker, entitled Floorplanning technique using multi-partitioning based on a partition cost factor for non-square shaped partitions.
[16] U.S. Pat. No. 5,521,837, issued May 28, 1996, to Frankle, et al., entitled Timing driven method for laying out a user's circuit onto a programmable integrated circuit device.
[17] S. Adya and I. Markov. Fixed-outline Floorplanning Through Better Local Search. In Proc. International Conference on Computer Design, pages 328-334, 2001.
[18] C. J. Alpert. The ISPD98 Circuit Benchmark Suite. In Proc. Int'l Symp. on Phys. Design, pages 80-85, 1998.
[19] Y. C. Chang, Y. W. Chang, G. Wu, and S. Wu. B*-trees: A New Representation for Non-Slicing Floorplans. In Proc. Design Automation Conference, pages 458-463, 2000.
[20] J. Cong, G. Nataneli, M. Romesis, and J. Shinnerl. An Area-Optimality Study of Floorplanning. In Proc. Int'l Symposium on Physical Design, pages 78-83, 2004.
[21] J. Cong, M. Romesis, and J. Shinnerl. Fast floorplanning by look-ahead enabled recursive bipartitioning. Technical Report TR040043, Computer Science Dept., University of California, Los Angeles, 2004.
[22] J. Cong, M. Romesis, and J. Shinnerl. Fast floorplanning by look-ahead enabled recursive bipartitioning. Proceedings of the Asia South Pacific Design Automation Conference, January 2005.
[23] J. Cong, M. Romesis and J. Shinnerl. Robust Mixed-Size Placement Under Tight White-Space Constraints. Proceedings of the 2005 IEEE/ACM International Conference on Computer Aided Design, San Jose, Calif., November, 2005.
[24] P. Guo, C. Cheng, and T. Yoshimura. An O-tree Representation of Non-slicing Floorplan and its Applications. In Proc. Design Automation Conf., pages 328-334, 1999.
[25] http://cadlab.cs.ucla.edu/cpmo/HBsuite.html/.
[26] X. Hong, S. Dong, G. Huang, Y. Ma, Y. Cai, C. Cheng, and J. Gu. A Non-slicing Floorplanning Algorithm Using Corner Block List Topological Representation. In Proc. Design Automation Conf., pages 268-273, 1999.
[27] G. Karypis, R. Aggarwal, V. Kumar, and S. Shekhar. Multilevel hypergraph partitioning: Application in vlsi domain. In Proc. 34th ACM/IEEE Design Automation Conference, pages 526-529, 1997.
[28] J. Lin and Y. Chang. TCG: A Transitive Closure Graph-Based Representation for Non-Slicing Floorplans. In Proc. Design Automation Conf., pages 764-769, 2001.
[29] H. Murata, K. Fujiyoshi, S. Nakatake, and Y. Kajitani. Rectangle packing-based module placement. In Proc. International Conference on Computer-Aided Design, pages 472-479, 1995.
[30] S. Nakatake, K. Fujiyoshi, H. Mirata, and Y. Kajitani. Module Packing Based on the BSG-structure and IC Layout Applications. In IEEE Transactions on Computer-Aided Design of Integrated Circuits and Systems, volume 17, pages 519-530, 1998.
[31] R. Otten. Automatic Floorplan Design. In Proc. Design Automation Conf., pages 261-267, 1982.
[32] A. Ranjan, K. Bazargan, S. Ogrenci, and M. Sarrafzadeh. Fast Floorplanning for Effective Prediction and Construction. In IEEE Trans. on VLSI Sys., pages 341-351, 2001.
[33] P. Sassone and S. K. Lim. A Novel Geometric Algorithm For Fast Wire-Optimized Floorplanning. In Proc. International Conference on Computer-Aided Design, 2003.
[34] P. Villarrubia, G. Nusbaum, R. Masleid, and E. Patel. IBM RISC chip design methodology. In ICCD, pages 143-147, 1989
[35] D. F. Wong and C. L. Liu. A New Algorithm for Floorplan Design. In Proc. Design Automation Conference, pages 101-107, 1986.
[36] A. Khatkhate, C. Li, A. R. Agnihotri, S. Ono, M. C. Yildiz, C.-K. Koh, and P. H. Madden. Recursive bisection based mixed block placement. In Proc. Int'l Symp. on Phys. Design, 2004.
[37] A. Kahng and Q. Wang. An analytic placer for mixed-size placement and timing-driven placement. In Proc. Int'l Conf. on Computer-Aided Design, pages 565-572, 2004.
[38] A. Kahng and Q. Wang. Implementation and extensibility of an analytic placer. In Proc. Int'l Symp. on Phys. Design, pages 18-25, 2004.
[39] C.-C. Chang, J. Cong, and X. Yuan. Multilevel placement for large-scale fixed-size IC designs. In Proc. Asia South Pacific Design Automation Conference, pages 325-330, 2003.
[40] H. Murata, K. Fujiyoshi, S. Nakatake, and Y. Kajitani. Rectangle-packing-based module placement. In Proc. International Conference on Computer-Aided Design, pages 472-479, 1995.

### CONCLUSION

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A method for placement or floorplanning of an integrated circuit, comprising:
constructing legal layouts at every level of a hierarchy of subsets of modules representing the integrated circuit, by scalably incorporating legalization into each level of the hierarchy, so that satisfiability of constraints is explicitly enforced at every level, in order to eliminate backtracking and post-hoc legalization.

2. The method of claim 1, wherein the hierarchy of subsets of modules is derived by top-down recursive partitioning of the modules.

3. The method of claim 2, wherein a partitioning objective is minimization of either weighted cutsize or displacement from a given global placement solution that has not yet been legalized.

4. The method of claim 2, wherein the constructing step comprises constructing legal look-ahead solutions, strictly satisfying all constraints, for every subproblem at each intermediate level, before optimizing partitioning is applied to that subproblem.

5. The method of claim 4, wherein a guarantor algorithm is used to compute the legal look-ahead solutions, and the guarantor algorithm determines whether objects assigned to each given subregion can be shaped and laid out within that subregion without violation of the constraints.

6. The method of claim 5, wherein, if all child subproblems of a given parent subproblem can be legalized by the guarantor algorithm, then recursive, optimizing partitioning continues on those child subregions at the current level, and the legal solution of the parent subproblem is discarded.

7. The method of claim 6, wherein partitioning coupled with subproblem legalization then resumes recursively on these subproblems, until single-module base cases are reached.

8. The method of claim 5, wherein, if some child subproblem cannot be legalized, then optimizing partitioning is not attempted on it or any of its siblings, and instead, an objective-reducing instantiation of the previously computed, legal, look-ahead solution to the parent subproblem is used.

9. The method of claim 8, wherein partitioning coupled with subproblem legalization then resumes recursively on these subproblems, until single-module base cases are reached.

10. The method of claim 1, wherein the hierarchy of subsets of modules is derived by recursive bottom-up aggregation or clustering of modules and subsets.

11. The method of claim 1, wherein the constructing step is performed using any combination of fixed-shape and variable-shape modules under tight fixed-outline area constraints and a wirelength objective.

12. The method of claim 1, wherein the method's objective is minimization of any combination of: estimated weighted wirelength, routability, signal timing delay, power consumption, temperature,

13. An apparatus for placement or floorplanning of an integrated circuit, comprising:
a processor; and
logic, performed by the processor, for constructing legal layouts at every level of a hierarchy of subsets of modules representing the integrated circuit, by scalably incorporating legalization into each level of the hierarchy, so that satisfiability of constraints is explicitly enforced at every level, in order to eliminate backtracking and post-hoc legalization.

14. The apparatus of claim 13, wherein the hierarchy of subsets of modules is derived by top-down recursive partitioning of the modules.

15. The apparatus of claim 14, wherein a partitioning objective is minimization of either weighted cutsize or displacement from a given global placement solution that has not yet been legalized.

16. The apparatus of claim 14, wherein the logic for constructing comprises logic for constructing legal look-ahead solutions, strictly satisfying all constraints, for every subproblem at each intermediate level, before optimizing partitioning is applied to that subproblem.

17. The apparatus of claim 16, wherein a guarantor algorithm is used to compute the legal look-ahead solutions, and the guarantor algorithm determines whether objects assigned to each given subregion can be shaped and laid out within that subregion without violation of the constraints.

18. The apparatus of claim 17, wherein, if all child subproblems of a given parent subproblem can be legalized by the guarantor algorithm, then recursive, optimizing partitioning continues on those child subregions at the current level, and the legal solution of the parent subproblem is discarded.

19. The apparatus of claim 18, wherein partitioning coupled with subproblem legalization then resumes recursively on these subproblems, until single-module base cases are reached.

20. The apparatus of claim 17, wherein, if some child subproblem cannot be legalized, then optimizing partitioning is not attempted on it or any of its siblings, and instead, an objective-reducing instantiation of the previously computed, legal, look-ahead solution to the parent subproblem is used.

21. The apparatus of claim 20, wherein partitioning coupled with subproblem legalization then resumes recursively on these subproblems, until single-module base cases are reached.

22. The apparatus of claim 13, wherein the hierarchy of subsets of modules is derived by recursive bottom-up aggregation or clustering of modules and subsets.

23. The apparatus of claim 13, wherein the logic for constructing is performed using any combination of fixed-shape and variable-shape modules under tight fixed-outline area constraints and a wirelength objective.

24. The apparatus of claim 13, wherein the logic's objective is minimization of any combination of: estimated weighted wirelength, routability, signal timing delay, power consumption, temperature,

25. An article of manufacture embodying logic for performing a method for placement or floorplanning of an integrated circuit, the method comprising:
constructing legal layouts at every level of a hierarchy of subsets of modules representing the integrated circuit, by scalably incorporating legalization into each level of the hierarchy, so that satisfiability of constraints is explicitly enforced at every level, in order to eliminate backtracking and post-hoc legalization.

26. The article of claim 25, wherein the hierarchy of subsets of modules is derived by top-down recursive partitioning of the modules.

27. The article of claim 26, wherein a partitioning objective is minimization of either weighted cutsize or displacement from a given global placement solution that has not yet been legalized.

28. The article of claim 26, wherein the constructing step comprises constructing legal look-ahead solutions, strictly satisfying all constraints, for every subproblem at each intermediate level, before optimizing partitioning is applied to that subproblem.

29. The article of claim 28, wherein a guarantor algorithm is used to compute the legal look-ahead solutions, and the guarantor algorithm determines whether objects assigned to each given subregion can be shaped and laid out within that subregion without violation of the constraints.

30. The article of claim 29, wherein, if all child subproblems of a given parent subproblem can be legalized by the guarantor algorithm, then recursive, optimizing partitioning continues on those child subregions at the current level, and the legal solution of the parent subproblem is discarded.

31. The article of claim 30, wherein partitioning coupled with subproblem legalization then resumes recursively on these subproblems, until single-module base cases are reached.

32. The article of claim 29, wherein, if some child subproblem cannot be legalized, then optimizing partitioning is not attempted on it or any of its siblings, and instead, an objective-reducing instantiation of the previously computed, legal, look-ahead solution to the parent subproblem is used.

33. The article of claim 32, wherein partitioning coupled with subproblem legalization then resumes recursively on these subproblems, until single-module base cases are reached.

34. The article of claim 25, wherein the hierarchy of subsets of modules is derived by recursive bottom-up aggregation or clustering of modules and subsets.

35. The article of claim 25, wherein the constructing step is performed using any combination of fixed-shape and variable-shape modules under tight fixed-outline area constraints and a wirelength objective.

36. The article of claim 25, wherein the method's objective is minimization of any combination of: estimated weighted wirelength, routability, signal timing delay, power consumption, temperature,
